(19) United States
(12) Patent Application Publication
(10) Pub. No.: US 2005/0136227 A1
(43) Pub. Date: Jun. 23, 2005

(54) Variable data heat transfer label

(75) Inventors: William A. Baldwin, London (GB); Eric M. Sutton, Middlesex (GB); David E. Zurawski, Clarence Center, NY (US); David B. Vaughn, North Tonawanda, NY (US)

Correspondence Address: WELSH & KATZ, LTD. (ILLINOIS TOOL WORKS), 120 S. RIVERSIDE PLAZA, CHICAGO, IL, 60606, US

(73) Assignee: Illinois Tool Works, Inc., Glenview, IL (US)

(21) Appl. No.: 10/742,297

(22) Filed: Dec. 19, 2003

(51) Int. Cl. B32B 3/00

(52) U.S. Cl. 428/195.1

(57) ABSTRACT

A heat transfer label for application to an item includes a heat transferable substrate having a translucent window area formed therein containing variable data. The heat transferable substrate is carried by a carrier web. The variable graphic component includes printed indicia on the translucent window area and is printed separate from and subsequent to the application of the substrate to the carrier. The variable graphic component is printed prior to application of the heat transfer label to the item and is visible through the window area when the label is applied to the object.

### BACKGROUND OF THE INVENTION

The present invention relates to indicia-containing labels. More particularly, the present invention relates to heat transfer labels containing variable data, which labels are applied to articles to provide unique markings.

Indicia and/or graphics-containing labels are in widespread use in most every industry. For example, labels are used in the garment industry to mark articles of clothing to identify the manufacturer, the size of the garment, to provide laundry instructions, composition of the fabric, manufacturing location information and the like. In such a marking, there is both fixed and variable data. The fixed data can include the manufacturer, manufacturing location and laundry instructions whereas the size of the garment and the composition of the fabric can be variable data.

Another market that uses labels is the durable goods market. In this market, labels may be used on, for example, hand held power tools. Such labels may include both fixed data, e.g., manufacturer's name and manufacturing location, and variable data, e.g., model number, serial number, and power (voltage and ampere) requirements.

One drawback to the use of individually printed labels (that is, labels with variable data) is that large inventories of completely finished pre-printed labels are needed at the manufacturing or packaging location. While this approach provides desirable information on an item-attached label, the large label inventory that is needed, in conjunction with the space necessary for storing such an inventory, makes this approach undesirable.

In addition, when such individualized or customized labels are used, they are maintained in large quantities in inventory. This increases the likelihood of label obsolescence. That is, there may well be a large quantity of completely finished labels in inventory when a product is changed or discontinued.

Accordingly, there is a need for a variable data heat transfer label that provides the flexibility to locally print variable, e.g., changeable data, immediately prior to applying the label to the item. Desirably, such a label includes some manner of fixed data and a translucent window in which the variable data is printed and through which the data is viewed when the label is affixed to an object or item.

### SUMMARY OF THE INVENTION

A heat transfer label for application to an item includes a heat transferable substrate having a translucent window area formed therein. The substrate is carried on a carrier.

A variable graphic component including printed indicia is printed on the translucent window area. The variable graphic component is printed separate from and subsequent to the application of the substrate to the carrier, but prior to application of the heat transfer label to the item.

Such a variable data heat transfer label provides the flexibility to locally print variable or changeable data immediately prior to applying the label to the item. A present label includes some manner of fixed data and a translucent window in which the variable data is printed, and through which the variable data is viewed.

These and other features and advantages of the present invention will be readily apparent from the following detailed description, in conjunction with the claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 is a schematic illustration of a master web having three rows of printed variable data heat transfer labels embodying the principles of the present invention, in which the labels are shown in one row having fixed graphics on top of the translucent window, in a second row having fixed graphics immediately adjacent to the window, and in a third row having no fixed graphics;

FIG. 2A illustrates a web having a single row of labels with both fixed graphics and variable data printed on top of the translucent windows;

FIG. 2B illustrates a web similar to that of FIG. 2A, except that the labels have only variable data printed on top of the translucent windows;

FIG. 3 shows an exemplary apparatus for printing variable data onto the labels;

FIG. 4 is a cross-sectional view of the label on the carrier web prior to application to an object;

FIG. 5A is a cross-sectional view of the label applied to an object in which the fixed and variable graphics are printed on top of the translucent window prior to application to the object;

FIG. 5B is a cross-sectional view of the label applied to an object in which the fixed graphics are printed adjacent to the translucent window and the variable graphics are printed on top of the translucent window prior to application to the object; and

FIG. 5C is a cross-sectional view of the label applied to an object in which variable graphics are printed on top of the translucent window prior to application to the object.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be understood that the title of this section of this specification, namely, “Detailed Description Of The Invention”, relates to a requirement of the United States Patent Office, and does not imply, nor should be inferred to limit the subject matter disclosed herein.

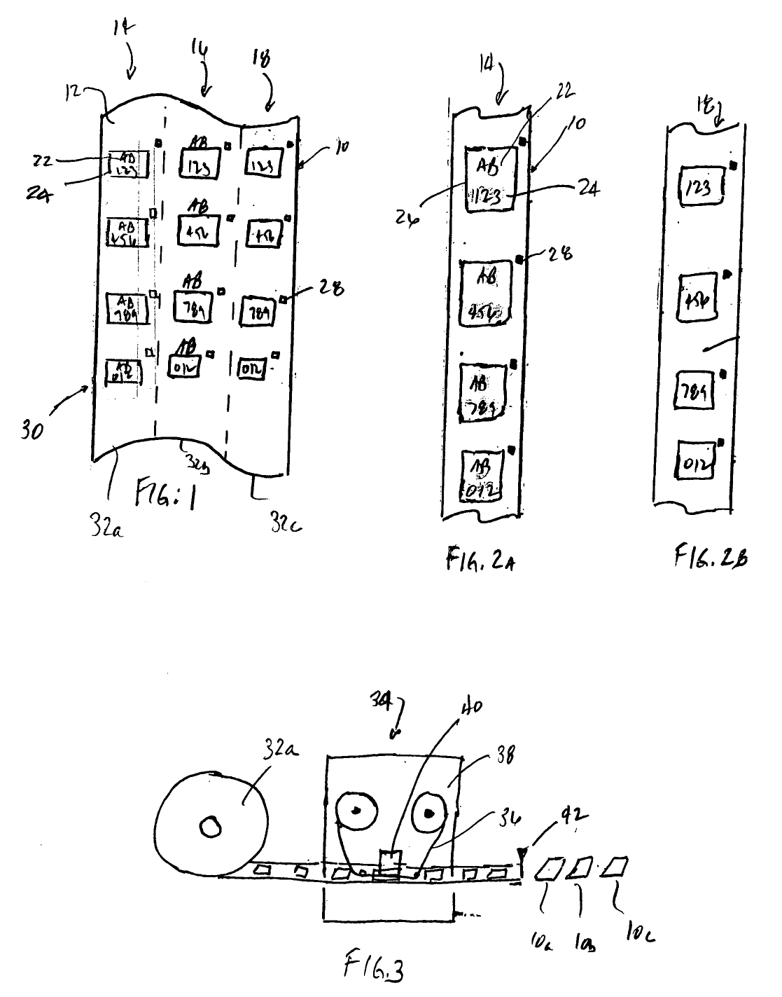

Referring now to the figures and briefly, to FIG. 1, there is shown one embodiment of a set of variable data heat transfer labels indicated generally at 10, embodying the principles of the present invention. In the illustrated embodiment, a carrier web 12 has three distinct rows 14, 16, 18 of discrete labels 10 on the carrier web 12. The discrete labels can be printed using a screen printing process; however, other processes can also be used including gravure, rotary screen, offset, combinations of printing processes, for example, rotary screen and flexo, and the like.

The present heat transfer labels 10 can be applied to an object (such as object 20 in FIG. 5A, which can be a “soft” item such as a fabric item of clothing or a “rigid” item, such a power tool) and provide a way in which the label 10 can contain both fixed data 22 and variable data 24. Such labels 10 allow a manufacturer to purchase rolls of heat transfer labels 10 with certain, desired fixed data 22 pre-printed and then print the appropriate labels with variable data 24 as need on-site. It will be understood that the fixed data 22 is shown as alpha or letter characters in the figures and that the variable data 24 is shown as numeric characters in the figures.

The carrier web 12 is typically a release-coated paper or plastic film. The release coating can be silicone based, or it can employ other release coatings that will be recognized by those skilled in the art. Typically, both sides of the carrier web have a release coating, and the release coatings will generally have different release characteristics. The printed side will generally have a tighter release than the non-printed side.

Each label 10 is formed with a translucent window area 26 and optionally fixed graphics 22. For purposes of the present disclosure, the terms graphics, data and indicia are used interchangeably to indicate the fixed printing 22 of the label 10 or the variable printing 24 on the label 10. The fixed graphics 22 can vary depending on the object 20 that is being decorated with the label 10. For example, the labels 10 can include fixed data 22, such as a manufacturer's name, manufacturing location, logos, trademarks and the like.

If the object 20 has a rigid, e.g., plastic form, the translucent window area 26 and fixed graphic 22 inks can be an acrylic, a vinyl, an epoxy, a polyester, a polystyrene or similar thermoplastic resin system. If the object is a fabric-based article, chemistries such as those disclosed in U.S. Pat. Nos. 4,256,795, 3,992,559 and 3,959,555 would be suitable for both the fixed graphics 22 and translucent window area 26, which patents are incorporated herein by reference.

The entirety of the “printed” area forms the label 10. That is, the translucent window 26 and the fixed graphics 22 (if used) that are printed on the web 12 constitute the label 10. In transferring the label 10 to the object 20, the label 10 itself softens and adheres to the object 20 by the application of heat and pressure.

Generally, the term “printing” connotes the application or transfer of colored or tinted indicia through the use of inks, dyes, pigments or the like. In the present label 10, the translucent window 26 material is “printed” on the carrier web 12 without a pigment or tint, thus providing the translucent characteristics of the window area 26.

The fixed graphic 22 can be printed on top of the discrete translucent window area 26 (as seen in row 14 in FIG. 1) or immediately adjacent to the window 26 (as seen in row 16). Alternately still, there may be situations where there is no need for fixed graphics at all, and in those cases, only a translucent window area 26 is printed (as seen in row 18).

In a preferred label 10, eye marks 28 are printed near the labels 10. These marks 28 can serve a variety of functions, such as providing a trigger for printing the variable graphic 24, for cutting the continuous roll of labels 10 into discrete single labels 10a,b,c (see FIG. 3) or for activating an application process, if, for example, the labels 10 are supplied to the application equipment in roll form. The eye marks 28 are not typically within the target label area in that the marks 28 are not generally transferred to the object 20.

Referring to FIG. 1, in a preferred form, a master roll 30 is slit down to yield individual rolls 32a,b,c (collectively 32) of material that are single width, i.e., rolls 32 having one row of labels 10. It is anticipated that rolls 32 in this single width form will be supplied to, for example, the article manufacturer.

The labels 10, as supplied, have the translucent window area 26, the associated eye mark 28 and the optional fixed graphics 22. The fixed graphics 22 can be single or multiple color as desired by the article manufacturer.

The variable data 24 is printed on the translucent window area 26 prior to applying the label 10 to the object 20. It is contemplated that the variable data 24 printing will done at a different time and in a step separate from the printing of the fixed graphics 22 and translucent window 26. In fact, it is anticipated that the variable data 24 will be printed at the article manufacturer's plant using a variable data 24 printing process. The variable data 24 printing process can be carried out using ink jet, thermal transfer ribbon, ion printing and like printing processes.

FIG. 3 illustrates one exemplary apparatus 34 for printing the variable data 24 using a thermal transfer ribbon 36. In this process, a roll 32a of preprinted labels having a translucent window area 26 and optionally fixed graphics 22 is fed into a variable data print unit printer 38. The variable graphics 24 are printed on to the translucent window area 26 by a print head 40. The patterned transfer of the coating from the ribbon 36 to the translucent window area 26 forms the variable data 24 images. The labels 10 containing the variable data are 24 then either cut into individual labels 10a,b,c using a cutting mechanism 42 or are rewound onto another roll (not shown). The thermal transfer ribbon 36 may have different types of coatings. Common commercially available coatings include resin, resin-wax and wax based compositions. A preferred coating composition will depend upon the composition of the translucent window area 26 and the performance requirements of the decorated object 20.

In an ink jet printing process (not shown), the variable information is printed on the translucent window area using liquid inks dispensed in a controlled pattern, e.g., as small ink droplets ejected from a computer controlled ink jet printing nozzle. The inks used in this process are aqueous or organic solvent based inks. Suitable organic solvents include, for example, ketones, alcohols, esters, or hydrocarbons. Preferred solvents are low boiling point compounds including ketones such as acetone and methyl ethyl ketone, alcohols such as ethanol, iso-propanol and n-propanol, esters such as ethyl acetate and n-propyl acetate, and hydrocarbons such as heptane and toluene. Other organic solvent based inks will be recognized by those skilled in the art.

The inks can also be curable type inks, such as those printed by an ink jet printer and cured by radiation, such as ultraviolet light, electron beam or infrared radiation. In a preferred process, the ink is cured after printing on the discrete translucent window area by exposing it to radiation from a suitable source. Radiation curing transforms the liquid ink into a solid form. Typically, such radiation curable inks provide good resistance to smearing.

Still another process (not shown) for printing the variable data is laser marking, in which the variable data is established by removing material from the discrete translucent window areas. In one process, the window areas are over-printed with a solid layer of colored ink during the original (fixed) printing of the label. The labels are then marked with the variable data by exposing the label to a laser capable of generating the required marks. When the graphics are to be viewed in what is referred to as a positive format, the marking involves the ablation (removal) of the colored ink in the non-image areas associated with the variable data.

Conversely, when the variable data is to be viewed in a reverse format, the image is developed by laser marking or engraving the data into the colored ink printed on the discrete translucent window areas. In this instance, the colored ink is removed (ablated) to generate the image and non-image areas are left unchanged on the translucent window areas.

Regardless of the manner in which the variable data 24 is printed, it is anticipated that a variable data 24 printing unit in a stand-alone configuration or as part of the application process will be used at the article manufacturer's facility.

In the stand-alone configuration, the variable data printing unit (such as the printing apparatus 34 of FIG. 3) prints the labels 10 at a location remote to the application station and labels 10 are delivered to an application machine station in either roll form or as discrete, single piece labels. This process allows the article manufacturer to have a different number of variable data printers as compared to the number of application machines. This also allows the variable data printer to be located in a central location within the facility to enhance security and provide better control of label inventory, both pre-printed and printed.

Alternately, the variable data printing unit can be associated with the heat transfer application machine. In this configuration, a roll of pre-printed labels is mounted on the printer-application machine, the labels are transported through the variable data printing unit where the variable data is printed, and then the labels are advanced into the application section of the machine for application to the article. In a variation of this concept, the label could be applied to the article first and then the article with the applied label is advanced into the variable data printing unit where the variable data is printed on to the already applied label.

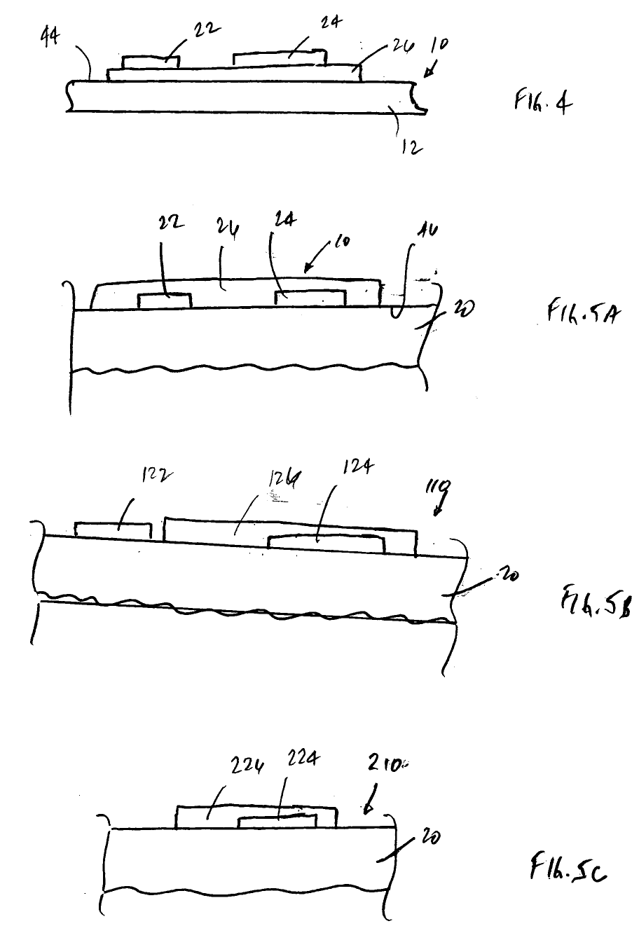

FIG. 4 illustrates a cross-sectional view of one embodiment of the label 10 prior to application to an object. The carrier web 12 has printed on its top surface 44 the discrete translucent window area 26. Fixed graphics 22 and variable graphics 24 are printed on top of the translucent window area 26. The fixed graphics 22 (if used) can be printed contemporaneously with the window area 26, whereas the variable data 24 is printed in a subsequent process.

FIGS. 5A-5C illustrate various label embodiments 10, 110, 210 as applied to objects 20. In FIG. 5A, the label 10 is applied to the object 20 at an exposed surface 46 of the label 10, such that both the fixed graphics 22 and the variable graphics 24 are in contact with the object 20 and are covered by the translucent window 26 material. That is, the fixed and variable graphics 22, 24 are sandwiched between the window 26 and the object 20. This serves to protect the variable data 24, while maintaining the variable data 24 visible through the translucent window 26. In the label 110 of FIG. 5B, the fixed graphic 122 and variable graphic 124 are in contact with the object 20, but only the variable graphic 124 is covered by the translucent window 126 material. Alternately as seen in the label 210 of FIG. 5C, the label 210 does not contain fixed data and, consequently, only variable graphics 224 and the translucent window 226 material are in contact with the object 20, with the window 226 overlying and protecting the variable data 224.

All patents referred to herein, are hereby incorporated herein by reference, whether or not specifically done so within the text of this disclosure.

In the disclosures, the words “a” or “an” are to be taken to include both the singular and the plural. Conversely, any reference to plural items shall, where appropriate, include the singular.

From the foregoing it will be observed that numerous modification and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A heat transfer label for application to an item, comprising:
a heat transferable substrate, the substrate including a translucent window area formed therein;
a carrier for carrying the substrate; and
a variable graphic component including printed indicia on the translucent window area printed separate from the application of the substrate to the carrier and on an opposing side of the substrate from the carrier, the variable graphic component being printed prior to application of the heat transfer label to the item.

2. The heat transfer label in accordance with claim 1 including a fixed graphic component having printed indicia on or adjacent the translucent window, the fixed graphic component being formed prior to printing the variable graphic component.

3. The heat transfer label in accordance with claim 2 wherein the fixed graphic component is printed at least in part within the translucent window area.

4. The heat transfer label in accordance with claim 2 wherein the fixed graphic component is printed at least in part outside of the translucent window area.

5. The heat transfer label in accordance with claim 1 including an indicating marker disposed on the carrier, the indicating marker being associated with the heat transfer label.

6. The heat transfer label in accordance with claim 5 wherein the indicating marker is disposed adjacent the translucent window area.

7. The heat transfer label in accordance with claim 1 wherein the heat transfer label is a first heat transfer label and including a second heat transfer label formed on the carrier adjacent the first heat transfer label, the second heat transfer label including a heat transferable substrate having a translucent window area formed therein and a second variable graphic component including printed indicia on the translucent window area printed on the second heat transfer label separate from the application of the substrate to the carrier and on an opposing side of the substrate from the carrier, the second variable graphic component being printed prior to application of the heat transfer label to the item and being different from the first heat transfer label variable graphic component.

8. The heat transfer label in accordance with claim 7 including a first indicating marker disposed on the carrier associated with the first heat transfer label and a second indicating marker disposed on the carrier associated with the second heat transfer label.

9. The heat transfer label in accordance with claim 8 wherein the first and second indicating markers are disposed adjacent the respective translucent window areas of their associated heat transfer labels.

10. The heat transfer label in accordance with claim 7 wherein the first and second heat transfer labels each include a fixed graphic component having printed indicia on or adjacent the respective labels' translucent window, the fixed graphic component being formed prior to printing the variable graphic component.

11. The heat transfer label in accordance with claim 10 wherein the fixed graphic component is printed at least in part within the respective labels' translucent window area.

12. The heat transfer label in accordance with claim 10 wherein the fixed graphic component is printed at least in part outside of the respective labels' translucent window area.

13. A method for making a heat transfer label for application to an item comprising the steps of:
providing a carrier web;
applying a heat transferable substrate having a translucent window area formed therein to the carrier web;
printing a variable graphic component including printed indicia on the translucent window area printed separate from the step of applying the heat transferable substrate, the variable graphic component printing step being carried out prior to application of the heat transfer label to the item.

14. The method in accordance with claim 13 wherein the step of applying the heat transferable substrate to the carrier web includes a step of printing on the web a fixed graphic component.

15. The method in accordance with claim 14 wherein the fixed graphic component is printed at least in part within the translucent window area.

16. The method in accordance with claim 14 wherein the fixed graphic component is printed at least in part outside of the translucent window area.

17. The method in accordance with claim 13 including the step of providing an indicating marker disposed on the web, the indicating marker being associated with the heat transfer label.

18. The method in accordance with claim 13 wherein the heat transferable substrate having a translucent window area formed therein is a first substrate, and including applying a second heat transferable substrate having a translucent window area formed therein to the carrier web adjacent the first substrate and printing a second variable graphic component including printed indicia on the translucent window area of the second heat transferable substrate, the second variable graphic component printed separate from the step of applying the heat transferable substrate, the printing of the second variable graphic component being carried out prior to application of the heat transfer label to the item.

19. The method in accordance with claim 18 including printing on the web a fixed graphic component associated with each of the first and second heat transferable substrates.

20. The method in accordance with claim 19 wherein the fixed graphic component is printed at least in part within the translucent window area of the respective heat transferable substrates.

21. The method in accordance with claim 19 wherein the fixed graphic component is printed at least in part outside of the translucent window area of the respective heat transferable substrates.

22. The method in accordance with claim 18 including the step of providing first and second indicating markers disposed on the web, each of the indicating markers being associated with a respective heat transfer label.
